(19) United States
(12) Patent Application Publication
(10) Pub. No.: US 2025/0279905 A1
(43) Pub. Date: Sep. 4, 2025

(54) Responding to Charging Requests

(71) Applicant: Telefonaktiebolaget LM Ericsson (publ), Stockholm (SE)

(72) Inventors: Indranil Chatterjee, Hooghly (IN); Saravanan M, Chennai (IN); Perepu Satheesh Kumar, Chennai (IN); Sudipta Dutta, Kolkata (IN)

(21) Appl. No.: 18/857,517

(22) PCT Filed: Apr. 21, 2022
(86) PCT No.: PCT/IN2022/050378

§ 371 Date: Oct. 17, 2024

(51) Int. Cl. H04L 12/14; H04L 9/40

(52) U.S. Cl. CPC H04L 12/1407; H04L 12/1432; H04L 63/08

(57) ABSTRACT

Methods and apparatus are provided. In an example aspect, a method in a first network node of responding to charging request is provided. The method comprises receiving, from a second network node, a plurality of first charging requests associated with a first subscriber, wherein each of the charging requests is associated with an amount of requested resource, and sending, to the second network node, a first predetermined response to each of the first charging requests. The method also comprises sending, to a third network node, a first accumulated charging request, wherein the first accumulated charging request is associated with an accumulated amount of requested resource that is accumulated from the amounts of requested resource in the first charging requests.

### TECHNICAL FIELD

Examples of the present disclosure relate to methods and apparatus for responding to charging requests, for example in a node in a network.

### BACKGROUND

With an ever-increasing number of devices in communication networks, such as wireless communication networks, session and event-based charging needs to be supported. For example, in a wireless communication network such as a 4G or 5G network, there may be a charging and rating system in which a request-response process between a Charge Trigger Function (CTF, also referred to in some examples as Session Management Function, SMF, in 5G) and a Charging Function (CHF) may be used to obtain authorization for a device to consume a resource such as data. The increasing number of devices may significantly increase the load on the charging and rating system.

Charging management in a 5G system is described for example in ETSI TS 132 290 V16.5.0, 5G; Telecommunication management; Charging management; 5G system; Services, operations and procedures of charging using Service Based Interface (SBI) (3GPP TS 32.290 version 16.5.0 Release 16). A simplified representation is provided in FIG. 1, which shows an example of a CTF and CHF interacting over Nchf_ConvergedCharging interface, and in FIG. 2, which shows an example of session based charging with Decentralized and Centralized Unit Determination, Centralized Rating, reproduced from ETSI TS 132 290 V16.5.0, FIG. 5.3.2.3.1.

### SUMMARY

In a communication network, for example, as the number of devices increases, charging related interactions (e.g. between a CTF/SMF and CHF) also increase, resulting in more and more resource utilization at the CHF. Embodiments proposed herein may for example improve the utilization of resources in one or more network nodes such as a CHF.

One aspect of the present disclosure provides a method in a first network node of responding to charging requests. The method comprises receiving, from a second network node, a plurality of first charging requests associated with a first subscriber, wherein each of the charging requests is associated with an amount of requested resource, and sending, to the second network node, a first predetermined response to each of the first charging requests. The method also comprises sending, to a third network node, a first accumulated charging request, wherein the first accumulated charging request is associated with an accumulated amount of requested resource that is accumulated from the amounts of requested resource in the first charging requests.

Another aspect of the present disclosure provides apparatus in a first network node for responding to charging requests. The apparatus comprises a processor and a memory. The memory contains instructions executable by the processor such that the apparatus is operable to receive, from a second network node, a plurality of first charging requests associated with a first subscriber, wherein each of the charging requests is associated with an amount of requested resource, send, to the second network node, a first predetermined response to each of the first charging requests, and send, to a third network node, a first accumulated charging request, wherein the first accumulated charging request is associated with an accumulated amount of requested resource that is accumulated from the amounts of requested resource in the first charging requests.

An additional aspect of the present disclosure provides apparatus in a first network node for responding to charging requests. The apparatus is configured to receive, from a second network node, a plurality of first charging requests associated with a first subscriber, wherein each of the charging requests is associated with an amount of requested resource, and send, to the second network node, a first predetermined response to each of the first charging requests. The apparatus is also configured to send, to a third network node, a first accumulated charging request, wherein the first accumulated charging request is associated with an accumulated amount of requested resource that is accumulated from the amounts of requested resource in the first charging requests.

### BRIEF DESCRIPTION OF THE DRAWINGS

For a better understanding of examples of the present disclosure, and to show more clearly how the examples may be carried into effect, reference will now be made, by way of example only, to the following drawings in which:

FIG. 1 shows an example of a CTF and CHF interacting over a Nchf_ConvergedCharging interface;

FIG. 2 shows an example of session based charging with Decentralized and Centralized Unit Determination, Centralized Rating;

FIG. 3 shows an example of a communication system according to embodiments of this disclosure;

FIG. 4 is a flow chart of an example of a method in a first network node of responding to charging requests;

FIG. 5 is a flow chart of an example of a method of classifying a subscriber;

FIG. 6 illustrates communications in a communication network according to an example of this disclosure; and

FIG. 7 is a schematic of an example of an apparatus 700 in a first network node of responding to charging requests.

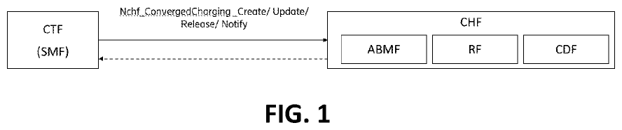

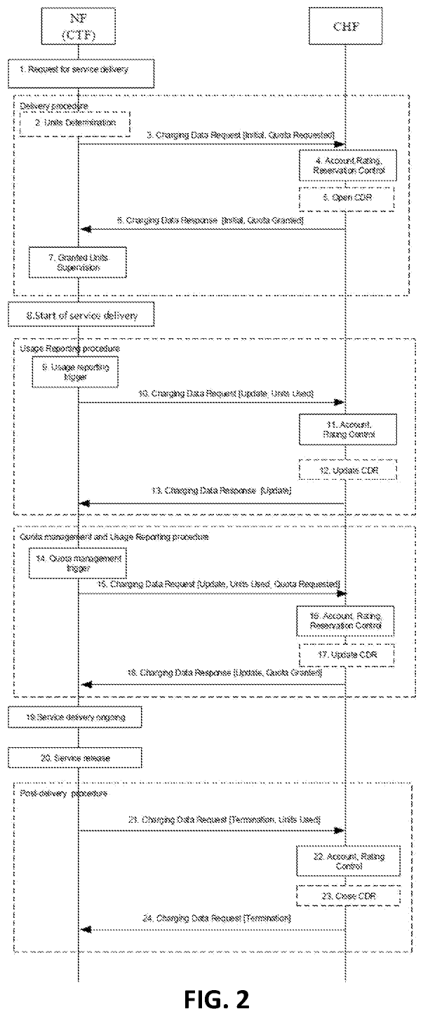

### DETAILED DESCRIPTION

The following sets forth specific details, such as particular embodiments or examples for purposes of explanation and not limitation. It will be appreciated by one skilled in the art that other examples may be employed apart from these specific details. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g. analog and/or discrete logic gates interconnected to perform a specialized function, Application Specific Integrated Circuits (ASICs), Programmable Logic Arrays (PLAs), etc.) and/or using software programs and data in conjunction with one or more digital microprocessors or general purpose computers. Nodes that communicate using the air interface also have suitable radio communications circuitry. Moreover, where appropriate the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g. digital or analogue) circuitry including but not limited to application specific integrated circuit(s) (ASIC) and/or field programmable gate array(s) (FPGA(s)), and (where appropriate) state machines capable of performing such functions.

As indicated above, in a communication network, such as for example a wireless communications network or 4G/5G network, as the number of devices increases, charging related interactions (e.g. between a CTF/SMF and CHF) also increase, resulting in more and more resource utilization at the CHF. Embodiments proposed herein may for example improve the utilization of resources in one or more network nodes such as a CHF.

A technique referred to as Dynamic Quota Allocation is intended to reduce the signaling exchange between CTF and CHF. Dynamic quota allocation is used to grant a high quota (i.e. granted amount of resource) to subscribers with a high usage of a resource (e.g. data) within a short time frame. Subscribers with a lower use will be granted a lower quota. The validity time for these quotas can also vary. The longer it is between interrogations of the CHF by the CTF for charging requests for a particular session, the lower the new quota for the session. If the interrogation time is lower than expected, the granted quota may be increased. For example, an operator may wish to keep the interrogations between 30-90 seconds. To achieve this, the granted quota may be divided by two in case the time since last interrogation is higher than 90 seconds. Accordingly, the granted quota may be doubled in case the time since last interrogation is lower than 30 seconds.

However, if there is a large number of devices, such as millions of devices for example, this may still result in a significant load on a network node such as CHF. Also, other devices, such as Internet of Things (IoT) or massive Internet of Things (mIoT) devices or devices that use enhanced mobile broadband (eMBB), may use different interrogation intervals as below. For example, it may be advantageous to keep CHF interrogations between 30-90 seconds for devices with eMBB subscriptions may keep the interrogations between 30-90 seconds, and between 30-90 minutes for devices with mloT subscriptions. Thus, the above technique may be unsuitable for such scenarios.

Embodiments of this disclosure provide a new network node, referred to for example as a Light CHF or Light CHF Receptor. This node may for example be lightweight and may in some examples be dynamically created or updated. In addition, examples of this disclosure may classify subscriptions, e.g. by using Artificial Intelligence (AI) or Machine Learning (ML), and redirect the responsibility for charging request-response session handling to a Light CHF Receptor according to classification. Some examples may have different and dynamic configurations for each Light CHF Receptor based on usage patterns.

Example embodiments may provide one or more of the following advantages. Example embodiments may for example improve charging system efficiency to meet to the growing number of devices and their charging session needs. Example embodiments propose introduction of an intermediate layer for offloading of charging session handling activities. This intermediate layer can in some examples be dynamically scaled up or down based on analytic insights. As an example, based on analytics and dynamic learning capability, specific situations such as temporal load increase may be handled. In some examples, the intermediate layer (e.g. the Light CHF node) may be lightweight in terms of computation complexity than a “full” CHF, which may in some examples reduce the overall total cost of ownership (TCO) compared to the case where the full CHF needs to be scaled up to meet the needs of a growing number of devices.

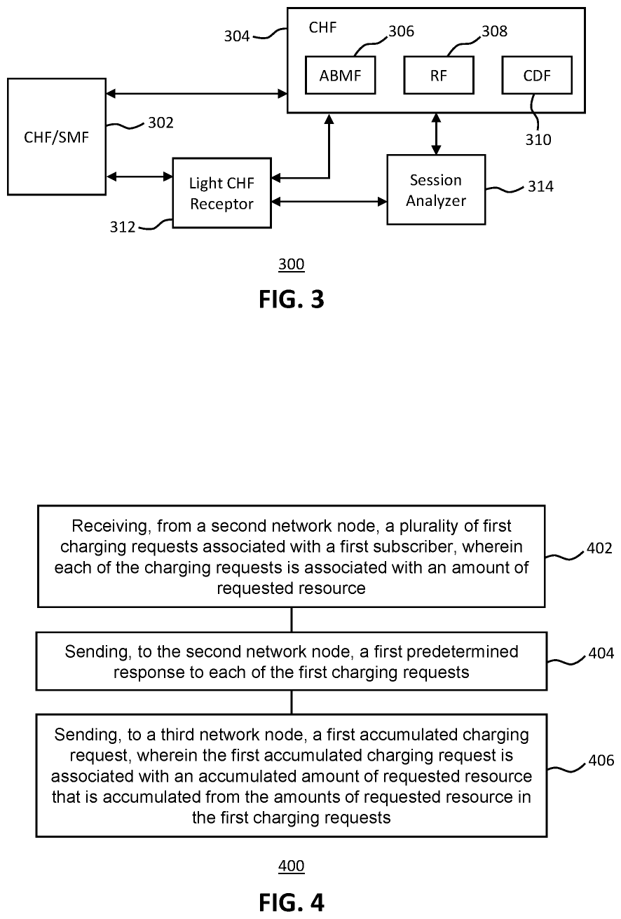

FIG. 3 shows an example of a communication system 300 according to embodiments of this disclosure. The communication system 300 may be part of a communications network, such as for example a wireless communications network, 4G network or 5G network. In some examples, the communication system may be part of a core network (CN) in a communications network. The communication system includes a Charge Trigger Function or Session Management Function (CHF/SMF) 302, which is in communication with a Charging Function (CHF) 304, for example over a Nchf_ConvergedCharging interface. The CHF 304 may include in the example shown an Account Balance Management Function (ABMF) 306, Rating Function (RF) 308 and Charging Data Function (CDF) 310. The CHF/SMF 302 is also in communication with a Light CHF Receptor 312. The Light CHF Receptor is in communication with the CHF 304, and also with a Session Analyzer 314. The Session Analyzer 314 is in communication with the CHF 304 or may be able to analyze communications between the CHF/SMF 302 and the CHF 304, for example over the Nchf_ConvergedCharging interface. The Session Analyzer 314 may in some examples be a function or component of a Network Data Analytics Function (NWDAF).

FIG. 4 is a flow chart of an example of a method 400 in a first network node of responding to charging requests. The first network node may be for example a Light CHF or Light CHF receptor as referred to herein, such as for example the Light CHF Receptor 312 shown in FIG. 3. The method comprises, in step 402, receiving, from a second network node, a plurality of first charging requests associated with a first subscriber, wherein each of the charging requests is associated with an amount of requested resource. The second network node may be for example a CHF or SMF, such as for example the CHF/SMF 302 shown in FIG. 3. Alternatively, for example, the second network node may be a CHF gateway, whose role is for example to receive charging requests from another node such as CTF/SMF and forward them to the first network node (which may in some examples be one of a plurality of first network nodes or Light CHF Receptors).

The first charging requests may be received for example over the Nchf_ConvergedCharging interface. As indicated above, each of the charging requests is associated with an amount of requested resource (e.g. amount of data, number of SMS/MMS messages, number of voice minutes, and/or any other resource). That is, for example, each request includes or identifies the amount of requested resource, or otherwise the amount of resource may be known to the first network node (e.g. by pre-configuration, other message from the second network node etc.).

Step 404 of the method 400 comprises sending, to the second network node, a first predetermined response to each of the first charging requests. The first predetermined response may in some examples be considered as a “standard” response that is sent in response to each of the first charging requests without any further processing, e.g. without checking account details, usage details, resource entitlement (e.g. amount of data on the subscriber's plan), etc. The first predetermined response to each first charging request may in some examples indicate grant or authorization of the amount of requested resource indicated in the first charging request. This may for example enable the subscriber to consume the amount of resource within a validity time. The first predetermined response may also in some examples indicate the validity time for the grant or authorization of the requested resource.

The method 400 also includes, in step 406, sending, to a third network node, a first accumulated charging request, wherein the first accumulated charging request is associated with (e.g. includes or identifies) an accumulated amount of requested resource that is accumulated from the amounts of requested resource in the first charging requests. The third network node may be for example a CHF such as the CHF 304 shown in FIG. 3. The accumulated amount of requested resource may be for example an accumulation or sum of the amounts of requests resource in the first charging requests, e.g. a sum of the amount of data requested in the first charging requests.

In some examples, the first subscriber is in a first group of subscribers, and wherein the first predetermined response is associated with the first group of subscribers. That is, for example, the first predetermined response may be sent to the second network node in response to each charging request received for any subscriber in the first subscriber group. The method 400 may therefore include, for example, receiving, from the second network node, one or more further charging requests associated with a further subscriber in the first group of subscribers, wherein each of the additional charging requests indicates an amount of requested resource. The first predetermined response to each of the one or more further charging requests may then be sent to the second network node. The method may then also comprise sending, to the third network node, a further accumulated charging request, wherein the first accumulated charging request indicates an accumulated amount of requested resource that is accumulated from the amounts of requested resource in the one or more further charging requests.

There may in some examples be one or more additional groups of subscribers. Each group may for example be associated with a respective additional predetermined response. The additional predetermined response for an additional subscriber group may be different to the additional predetermined response for at least one other subscriber group of the additional subscriber groups and/or the first predetermined response for the first subscriber group. In some examples, the method 400 further comprises receiving, from the second network node, one or more additional charging requests associated with an additional subscriber in one of the one or more additional subscriber groups, wherein each of the additional charging requests is associated with (e.g. includes or indicates) an amount of requested resource. The method 400 may also include sending, to the second network node, the additional predetermined response associated with the one of the one or more additional subscriber groups to each of the one or more further charging requests. Also, the method 400 may further comprise sending, to the third network node, an additional accumulated charging request, wherein the additional accumulated charging request indicates an accumulated amount of requested resource that is accumulated from the amounts of requested resource in the one or more additional charging requests. Thus, for example, in general, a charging request received from the second network node for a subscriber in a subscriber group may be responded to with a predetermined response associated with that group.

In some examples, before receiving the plurality of first charging requests, each of a plurality of subscribers (including the first subscriber) may be assigned, for example by the first network node, to a respective group of the first group and one or more additional subscriber groups. Each subscriber may be assigned to the respective group for example based on an amount of requested resource associated with one or more previous charging requests associated with the subscriber sent by the second network node. Each subscriber may in some examples be assigned to the respective group based further on one or more of the following: a validity time of grant or authorization of the amount of requested resource indicated in a response, sent by the third network node, to each of the previous charging requests; one or more additional parameters associated with the one or more previous charging requests; and/or other information.

Assigning each of the plurality of subscribers to a respective group may in some examples comprise using a clustering or unsupervised learning algorithm to assign each of the plurality of subscribers to a respective group. Examples of such a clustering algorithm may include k-means clustering, k-medioids clustering, dynamic clustering or hierarchical clustering.

In some examples, there may be a new subscriber that is not associated with any group. For example, a charging request may be received from the second network node for such a subscriber. In such cases, the method 400 may comprise receiving, from the second network node, one or more charging requests associated with a new subscriber, wherein each of the one or more charging requests associated with the new subscriber indicates an amount of requested resource. The new subscriber may then be assigned (e.g. by the first network node) to a subscriber group (e.g. one of the first group and the one or more additional subscriber groups) based on the amount of requested resource indicated in each of the one or more charging requests associated with the new subscriber. The new subscriber may also in some examples be assigned to the group based further on one or more of the following: a validity time of grant or authorization of the amount of requested resource indicated in a response, sent by the third network node, to each of the one or more charging requests associated with the new subscriber; one or more additional parameters associated with the response; and/or other information.

Assigning the new subscriber to a group may in some examples comprise using a clustering or unsupervised learning algorithm to assign the new subscriber to a group, for example k-means clustering, k-medioids clustering, dynamic clustering or hierarchical clustering. For example, assigning the new subscriber to a group of the first group and the one or more additional subscriber groups is performed based on the distance of a point representing the new subscriber to a centroid of one or more of the subscriber groups being below a threshold. That is, for example, if the point is close enough to the centroid of one of the existing groups, then it is assigned to one of the existing groups (e.g. the one with the closest centroid), instead of a new group (see below). The point representing the new subscriber may for example be based on the amount of requested resource indicated in each of the one or more charging requests associated with the new subscriber and/or a validity time of grant or authorization of the amount of requested resource indicated in a response, sent by the third network node, to each of the one or more charging requests associated with the new subscriber.

In other examples, a new subscriber may be assigned to a new group. Thus, for example, the method 400 may comprise receiving, from the second network node, one or more charging requests associated with a new subscriber, wherein each of the one or more charging requests associated with the new subscriber indicates an amount of requested resource. The method 400 may also comprise assigning the new subscriber to a new group based on the amount of requested resource indicated in each of the one or more charging requests associated with the new subscriber. The new subscriber may in some examples be assigned to the new group based further on a validity time of grant or authorization of the amount of requested resource indicated in a response, sent by the third network node, to each of the one or more charging requests associated with the new subscriber. Assigning the new subscriber to a group of the first group and the one or more additional subscriber groups may in some examples be performed based on the distance of a point representing the new subscriber to a centroid of one or more clusters associated with the first subscriber group and/or the one or more additional subscriber groups being below a threshold. The point representing the new subscriber may for example be based on the amount of requested resource indicated in each of the one or more charging requests associated with the new subscriber and/or a validity time of grant or authorization of the amount of requested resource indicated in a response, sent by the third network node, to each of the one or more charging requests associated with the new subscriber.

In some examples, sending, to the third network node, the first accumulated charging request in step 406 of the method 400 is performed in response to receiving a predetermined number of charging requests associated with the first subscriber and/or after a predetermined time associated with the first subscriber.

In some examples, assigning a subscriber to a group (either a new group or an existing group), and/or initial assignment of subscribers to groups, may be done by the first network node (e.g. based on information provided by the session analyzer 314 shown in FIG. 3) or may be done by another node such as the session analyzer 314 and communicated to the first network node. The assignment or clustering may use one or more fields in charging requests from the second network node (e.g. CTF/SMF 302) for the subscribers. Examples of such fields include nfConsumerIdentification, invocationTimeStamp, ratingGroup, requestedUnit (e.g. the amount of requested resource), userInformation, pduSessionInformation, grantedUnit (e.g. the amount of granted resource), and any other fields in the charging requests. In some examples, other information may also be used, such as for example UE Category for the devices used by the subscribers, and/or geographical position of the subscribers or devices.

An example of assignment of subscribers to groups using clustering is as follows. The node performing the clustering (e.g. the first network node or session analyzer 314) may use for example K Means Clustering, Dynamic Clustering or Hierarchical Clustering to identify K clusters. For example, clusters are identified where for each cluster of subscriptions or devices, a charging request to the third network node (e.g. CHF 304) and the response are similar, such as within a predictable range. In a particular example, clusters are identified where charging requests and/or responses in a first cluster have characteristics such as requested or granted resource amount within a range 100 KB-200 KB, and validity time 120-240 seconds. A second cluster may have characteristics such as requested or granted resource amount 1000 KB-2000 KB and validity time 300-600 seconds. A third cluster may have characteristics such as requested or granted resource amount 1000 KB-2000 KB and validity time 3600-7200 seconds. This is merely an illustrative example, and other examples may include a different number of clusters, different ranges, a different number of characteristic ranges in each cluster, and/or different characteristics.

In this example, each device or subscription (which may be identified using a Subscription Permanent Identifier, SUPI, in examples of this disclosure) is assigned to one cluster, or in some examples a default cluster. Once a cluster of subscriptions is determined, a response to a charging request may be determined for the cluster based on responses to charging requests from the third network node (e.g. CHF), and thus the predetermined response for the cluster may be determined. For example, the predetermined response may simply grant the requested amount of resource (which may or may not be specified in the predetermined response) with the expected validity time determined based on previous responses from the CHF for subscriptions in that cluster or group. In some examples, Policy and Charging Control (PCC) rules may be created such that charging requests (e.g. from the second network node or CTF/SMF) are directed to the first network node, which may be for example a Light CHF Receptor as referred to above. In an example, the first network node may provide a predetermined response to charging requests, e.g. a quota (or granted amount of resource, where the resource is data) of 1000 KB and a validity time of 60 seconds. For each subscriber or SUPI, a counter value may in some examples be used to safeguard against balance overrun, explained further below. The first network node may thus accumulate the amount of requested resource in multiple charging requests for one subscriber/SUPI, and in some examples also per session, up to a predetermined number of charging requests and/or within a predetermined time, from the start the session. Once this predetermined number or time is reached, the first network node sends the accumulated charging request that includes the accumulated amount of resource (e.g. sum of requested amounts) to the “full” CHF for rating and account balance management for the subscriber. As the first network node or Light CHF Receptor can be simple in its logic, it can be less complex or resource intensive, and more cost efficient, than the full CHF. In some examples, the first network node may be implemented as a cloud-based containerized application that can be created or destroyed on demand, and there may in some examples also be multiple first network nodes, such as for example one first network node/Light CHF for each cluster of subscribers.

Some examples of this disclosure use self-supervised learning such as clustering to assign subscribers to groups or clusters. Supervised learning usually requires a lot of labelled data.

However, obtaining good quality labelled data may be an expensive and time-consuming task. On the other hand, unlabelled data is often available in abundance. The motivation behind self-supervised learning is to learn useful representations or groupings of the data from an unlabelled pool of data using self-supervision, and then optionally fine-tuning the representations with a small number of labelled data.

To perform clustering, in some examples, an initial set of clusters is first obtained. As suggested above, self-supervised or unsupervised learning may be used, e.g. using a clustering algorithm such as K Means, K Medioids etc. Finally, these clusters may be labelled. For each cluster, for example, the response pattern may be averaged and used as a label for the classification. For new data, such as a new subscriber or a change in usage pattern of an existing subscriber for example, a classification model may be used to assign the subscriber to a cluster. Each cluster in some examples corresponds to specific charging request and/or response pattern (e.g. amount of resource and/or validity time within a certain range).

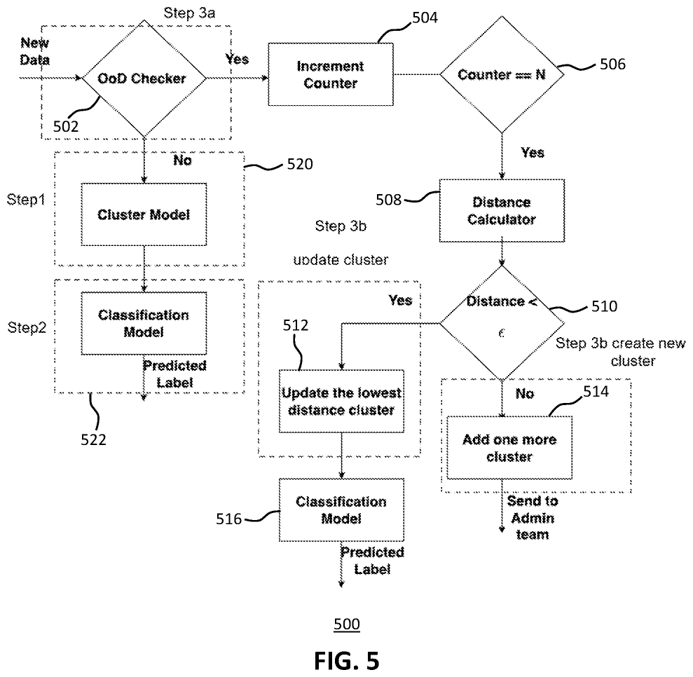

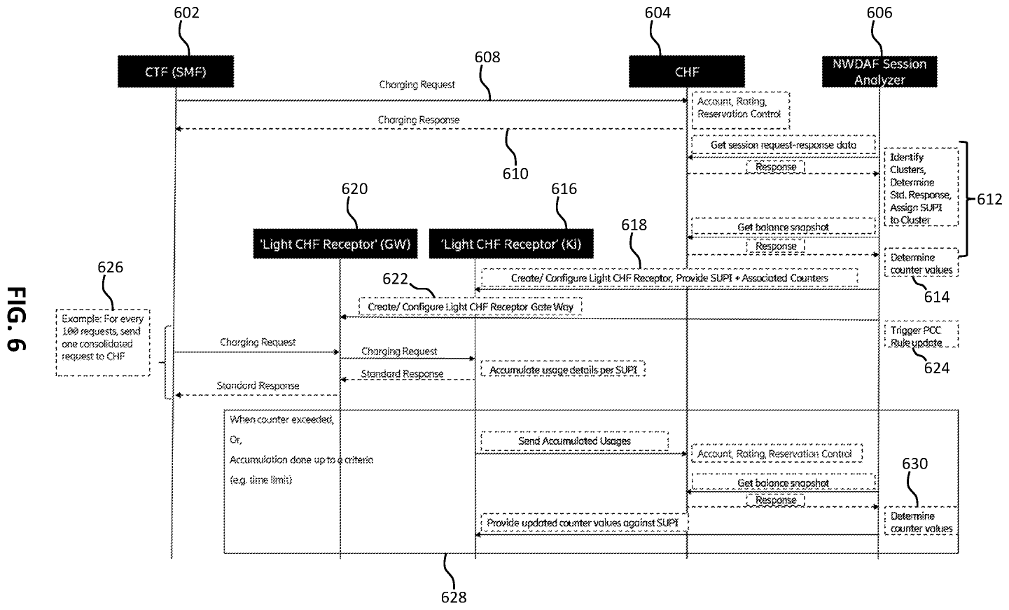

FIG. 5 is a flow chart of an example of a method 500 of classifying a subscriber. In step 502, it is determined whether new data (e.g. a new subscriber) is Out of Distribution (OoD). First (e.g. before the method 500), initial clusters of subscribers may be created using any of the available clustering algorithms. Further, a classification model may be trained to predict the cluster for every subscriber the new data will fall into. If the model confidence is less than the threshold, we will label the subscriber as outlier. This is a way to detect Out of Distribution (OoD) data. Any suitable method may be used to detect OoD points.

If the new data point is an OoD point then the method 500 proceeds to step 504 where a counter is incremented. If the counter reaches a pre-defined number N, as determined in step 506, then the method 500 proceeds to step 508 where the distance of each OoD subscriber point to the center (or centroid) of each of the clusters is calculated. The subscriber point may be based for example on the amount of requested resource in one or more charging requests from the new subscribers, and/or the granted amount and/or validity time in responses from the third network node (e.g. CHF). The point may also be based in some examples on other fields in the charging request/response or other information. In some examples, for the new subscriber, interaction between the second and third network nodes for the charging requests and responses may be allowed (i.e. without sending the predetermined response or the accumulated charging request for the subscriber) for a configurable minimum number of times, and the communications monitored. Once there is sufficient number of samples, the distance from the subscriber point to each of the clusters is calculated in step 508. In this case, the subscriber point may be based for example on an average or other combination of one or more values (amount of resource, validity time etc) in the charging requests and/or responses.

If the maximum distance to any cluster center/centroid is less than a threshold, as determined in step 510, then the cluster for each OoD data/subscriber will be chosen to be the closest cluster, and the cluster is updated in step 512 (e.g. to update the center/centroid). Otherwise, if the maximum distance is greater than the threshold, then instead in step 514 a new cluster is created including those points whose distance to any cluster is above the threshold. In this way, a new cluster may be created and/or existing clusters updated with the OoD points. Finally, the classification model may be updated in step 516.

In this example, each cluster corresponds to a usage pattern as described previously, and the classification model is trained to predict the cluster label for a new incoming subscription. The model trained can be for example a deep learning model or a simple decision tree model. If the new subscriber point is determined to be not out of distribution (OoD) in step 502, then in step 520 the trained model is used to predict the cluster it will fall into.

As indicated above, in step 512, new data points may be added to the clusters and the clusters modified. However, modifying clusters may have a large computational complexity. To reduce the computational complexity, only a single cluster is updated in some examples. For this, the distance of all the new data points to all the cluster centers/centroids is calculated, and the cluster which has smallest distance is updated. For example, the cluster that has the smallest average distance to all the new data points is updated.

In some examples, following step 514 of the method 500 in which a new cluster is added, details of the new cluster may be sent to an administrator or admin team who may configure the cluster, e.g. configure the parameters and values that will be included in the predetermined response for the cluster. This may also be done for clusters created before the method 500 in some examples.

In some examples, after identifying a cluster for a subscriber and assigning the subscriber to the cluster, a list of subscribers and the maximum counter value for each subscriber may be passed to a first network node or Light CHF Receptor that handles charging requests for subscribers in the cluster. The maximum counter value denotes the maximum number of charging requests allowed for a subscriber per time period. In some examples, the counter value is calculated as Balance/Standard Quota, and for a shared subscription where multiple users or subscribers use the same subscription or balance, the counter value may be calculated as Balance/(Standard Quota*number of users or subscribers).

If the maximum counter value (for the number of received charging requests associated with a subscriber) is reached for a subscriber, the accumulated charging request including the accumulated amount of requested resource is passed to the third network node and new counter values may in some examples be calculated.

FIG. 6 illustrates communications in a communication network according to an example of this disclosure, where the communication network includes a CTF (SMF) 602, CHF 604 and NWDAF session analyzer 606. Communication steps shown in FIG. 6 include the following:
1. Initially the CTF 602 sends charging requests for subscribers (each subscriber also being referred to as a SUPI) to CHF 604, in step 608.
2. CHF responds back with information including for example granted unit amount, validity time etc., in step 610.
3. After sufficient number of request-response occurrences, the Session Analyzer 606, part of NWDAF, performs analysis in steps 612 (including retrieving session request-response data and balances from CHF 604) resulting in:
   a. Identification of clusters of subscribers,
   b. Determining the predetermined response for each cluster,
   c. Assigning each subscriber to a cluster.
4. Based on the balance (e.g. the remaining or available resource entitlement for the subscriber, i.e. account balance), session analyzer 606 calculates a counter value for each subscriber in step 614 (e.g. maximum counter value as referred to above).
5. Then Session Analyzer 606 initiates the Light CHF Receptor(s) Ki 616 (where Ki, i=1, . . . ,n denotes Light CHF Receptor i, where there are n Receptor(s)) and provides each Light CHF Receptor 616 with the following information in step 618:
   a. Predetermined response parameters for cluster(s) handled by the Light CHF Receptor,
   b. Associated SUPIs and counter values.
6. Also, one Light CHF Receptor (Gateway, GW) 620 is created in step 622 which can act as the Gateway towards CTF 602. This node will have information on which SUPI is handled by which Receptor Ki 616 and can pass the request-response accordingly to the correct Receptor 616.
7. Then the Session Analyzer 606 triggers a workflow on creating PCC rules in Policy Control Function (PCF) in step 624. These PCC rules will tell CTF 602 the updated Charging Address, i.e. the Light CHF Receptor Gateway 620 address.
8. Now the Light CHF Receptor (the GW 620 and/or the “full” Receptor 616) is ready to handle requests from CTF.
9. The (or each) Light CHF Receptor 616 accumulates amounts of requested resources against each SUPI associated with it, and sends a predetermined response back to CTF 602, in steps 626.
10. If the maximum counter value is exceeded, or at certain configured intervals, the accumulated charging request is sent to CHF 604 where actual rating and account balance management takes place, in steps 628.
11. After that, Session Analyzer 606 again calculates the counter values in step 630 and sends updated counter values against the SUPIs to the respective Light CHF Receptor 616.

Nodes described herein such as for example the Session Analyzer and Light CHF Receptor nodes can be implemented in some examples using Kubernetes. This is an open-source container orchestration system maintained by the Cloud Native Computing Foundation. The main reasons for this consideration include:
Native containerization and Docker support.
The ability to run application components in full isolation of each other, while enjoying the cost-efficiency of a shared infrastructure. In this case different application replications of the same image of Light CHF Receptor can be run in Kubernetes. However, each can be identified by the distinguished Label & the Service name attributed to it while starting it.

Kubernetes runs the workload by placing containers into Pods to run on Nodes. A node may be a virtual or physical machine. Each node is managed by the control plane and contains the services necessary to run Pods. In this context, the “one-container-per-Pod” model is suggested. In this case, the Pod acts as a wrapper around a single web container. The web container hosts either of the suggested nodes, e.g. Session Analyzer or Light CHF Receptor. Hence there is only application instance per pod considered in this setup. Kubernetes manages Pods and its vertical scaling, rather than managing the containers directly.

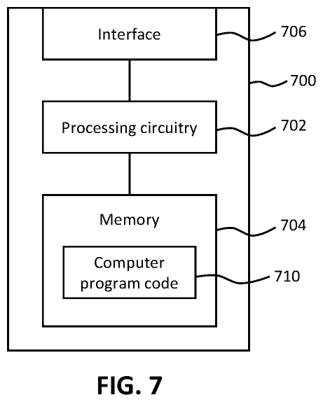

FIG. 7 is a schematic of an example of an apparatus 700 in a first network node of responding to charging requests. The apparatus 700 comprises processing circuitry 702 (e.g. one or more processors) and a memory 704 in communication with the processing circuitry 702. The memory 704 contains instructions, such as computer program code 710, executable by the processing circuitry 702. The apparatus 700 also comprises an interface 706 in communication with the processing circuitry 702. Although the interface 706, processing circuitry 702 and memory 704 are shown connected in series, these may alternatively be interconnected in any other way, for example via a bus.

In one embodiment, the memory 704 contains instructions executable by the processing circuitry 702 such that the apparatus 700 is operable/configured to receive, from a second network node, a plurality of first charging requests associated with a first subscriber, wherein each of the charging requests is associated with an amount of requested resource; send, to the second network node, a first predetermined response to each of the first charging requests; and send, to a third network node, a first accumulated charging request, wherein the first accumulated charging request is associated with an accumulated amount of requested resource that is accumulated from the amounts of requested resource in the first charging requests. In some examples, the apparatus 700 is operable/configured to carry out the method 400 described above with reference to FIG. 4.

It should be noted that the above-mentioned examples illustrate rather than limit the invention, and that those skilled in the art will be able to design many alternative examples without departing from the scope of the appended statements. The word “comprising” does not exclude the presence of elements or steps other than those listed in a claim, “a” or “an” does not exclude a plurality, and a single processor or other unit may fulfil the functions of several units recited in the statements below. Where the terms, “first”, “second” etc. are used they are to be understood merely as labels for the convenient identification of a particular feature. In particular, they are not to be interpreted as describing the first or the second feature of a plurality of such features (i.e., the first or second of such features to occur in time or space) unless explicitly stated otherwise. Steps in the methods disclosed herein may be carried out in any order unless expressly otherwise stated. Any reference signs in the statements shall not be construed so as to limit their scope.

1.-33. (canceled)

34. A method in a first network node of responding to charging requests, the method comprising:
receiving, from a second network node, a plurality of first charging requests associated with a first subscriber, wherein each of the charging requests is associated with an amount of requested resource;
sending, to the second network node, a first predetermined response to each of the first charging requests; and
sending, to a third network node, a first accumulated charging request, wherein the first accumulated charging request is associated with an accumulated amount of requested resource that is accumulated from the amounts of requested resource in the first charging requests.

35. The method of claim 34, wherein the first predetermined response to each first charging request indicates grant or authorization of the amount of requested resource indicated in the first charging request.

36. The method of claim 34, wherein the first predetermined response indicates a validity time for the grant or authorization of the requested resource.

37. The method of claim 34, wherein the first subscriber is in a first group of subscribers, wherein the first predetermined response is associated with the first group of subscribers, and wherein the method further comprises:
receiving, from the second network node, one or more further charging requests associated with a further subscriber in the first group of subscribers, wherein each of the additional charging requests indicates an amount of requested resource;
sending, to the second network node, the first predetermined response to each of the one or more further charging requests; and
sending, to the third network node, a further accumulated charging request, wherein the first accumulated charging request indicates an accumulated amount of requested resource that is accumulated from the amounts of requested resource in the one or more further charging requests.

38. The method of claim 37, further comprising:
receiving, from the second network node, one or more additional charging requests associated with an additional subscriber in one of one or more additional subscriber groups, wherein each of the additional charging requests indicates an amount of requested resource;
sending, to the second network node, an additional predetermined response associated with the one of the one or more additional subscriber groups to each of the one or more further charging requests; and
sending, to the third network node, an additional accumulated charging request, wherein the additional accumulated charging request indicates an accumulated amount of requested resource that is accumulated from the amounts of requested resource in the one or more additional charging requests.

39. The method of claim 38, wherein each subscriber group of the one or more additional subscriber groups is associated with a respective additional predetermined response, wherein the additional predetermined response for an additional subscriber group is different from the additional predetermined response for at least one other subscriber group of the additional subscriber groups and/or the first predetermined response for the first subscriber group.

40. The method of claim 38, further comprising, before receiving the plurality of first charging requests, assigning each of a plurality of subscribers including the first subscriber to a respective group of the first group and the one or more additional subscriber groups, wherein said assigning comprises assigning each subscriber to the respective group based on an amount of requested resource associated with one or more previous charging requests associated with the subscriber sent by the second network node.

41. The method of claim 40, wherein said assigning comprises assigning each subscriber to the respective group based further on:
a validity time of grant or authorization of the amount of requested resource indicated in a response, sent by the third network node, to each of the previous charging requests; and/or
one or more additional parameters associated with the one or more previous charging requests.

42. The method of claim 40, wherein assigning each of the plurality of subscribers to a respective group comprises using a clustering or unsupervised learning algorithm to assign each of the plurality of subscribers to a respective group.

43. The method of claim 40, further comprising:
receiving, from the second network node, one or more charging requests associated with a new subscriber, wherein each of the one or more charging requests associated with the new subscriber indicates an amount of requested resource; and
assigning the new subscriber to a group of the first group and the one or more additional subscriber groups based on the amount of requested resource indicated in each of the one or more charging requests associated with the new subscriber.

44. The method of claim 43, wherein assigning the new subscriber to a group comprises using a clustering or unsupervised learning algorithm to assign the new subscriber to a group, wherein assigning the new subscriber to a group of the first group and the one or more additional subscriber groups is performed based on the distance of a point representing the new subscriber to a centroid of one or more of the subscriber groups being below a threshold.

45. The method of claim 44, wherein the point representing the new subscriber is based on the amount of requested resource indicated in each of the one or more charging requests associated with the new subscriber and/or a validity time of grant or authorization of the amount of requested resource indicated in a response, sent by the third network node, to each of the one or more charging requests associated with the new subscriber.

46. The method of claim 40, further comprising:
receiving, from the second network node, one or more charging requests associated with a new subscriber, wherein each of the one or more charging requests associated with the new subscriber indicates an amount of requested resource; and
assigning the new subscriber to a new group based on the amount of requested resource indicated in each of the one or more charging requests associated with the new subscriber.

47. The method of claim 46, wherein assigning the new subscriber to a group of the first group and the one or more additional subscriber groups is performed based on the distance of a point representing the new subscriber to a centroid of one or more clusters associated with the first subscriber group and/or the one or more additional subscriber groups being below a threshold.

48. The method of claim 47, wherein the point representing the new subscriber is based on the amount of requested resource indicated in each of the one or more charging requests associated with the new subscriber and/or a validity time of grant or authorization of the amount of requested resource indicated in a response, sent by the third network node, to each of the one or more charging requests associated with the new subscriber.

49. The method of claim 34, wherein sending, to the third network node, the first accumulated charging request is performed in response to receiving a predetermined number of charging requests associated with the first subscriber and/or after a predetermined time associated with the first subscriber.

50. The method of claim 34, wherein:
the second network node comprises a Charging Trigger Function (CTF) or a Session Management Function (SMF); and/or
the third network node comprises a Charging Function (CHF).

51. The method of claim 34, wherein:
each of the first charging requests includes or identifies the amount of requested resource; and/or
the first accumulated charging request includes or identifies the accumulated amount of requested resource.

52. A first network node for responding to charging requests, the first network node comprising a processor and a memory, the memory containing instructions executable by the processor such that the first network node is operable to:
receive, from a second network node, a plurality of first charging requests associated with a first subscriber, wherein each of the charging requests is associated with an amount of requested resource;
send, to the second network node, a first predetermined response to each of the first charging requests; and
send, to a third network node, a first accumulated charging request, wherein the first accumulated charging request is associated with an accumulated amount of requested resource that is accumulated from the amounts of requested resource in the first charging requests.

53. A non-transitory computer readable storage medium on which is stored instructions which, when executed by at least one processor of a first network node, cause the first network node to:
receive, from a second network node, a plurality of first charging requests associated with a first subscriber, wherein each of the charging requests is associated with an amount of requested resource;
send, to the second network node, a first predetermined response to each of the first charging requests; and
send, to a third network node, a first accumulated charging request, wherein the first accumulated charging request is associated with an accumulated amount of requested resource that is accumulated from the amounts of requested resource in the first charging requests.
